(19) United States
(12) Patent Application Publication
(10) Pub. No.: US 2026/0359661 A1
(43) Pub. Date: Nov. 12, 2026

(54) DISTRIBUTED ARTIFICIAL INTELLIGENCE INFRASTRUCTURE AND ORCHESTRATION SYSTEM FOR HOME NETWORKS

(71) Applicant: PLUME DESIGN, INC., Palo Alto, CA (US)

(72) Inventors: Richard CHANG, Los Altos Hills, CA (US); MingShu LIU, Hsinchu (TW); JianShing LI, Campbell, CA (US); Miroslav SAMARDZIJA, Mountain View, CA (US); Dinh Hieu Liem VO, Saratoga, CA (US); Xiaowei QIAN, Suzhou (CN); Cooper CHEN, Hsinchu (TW); James WU, Hsinchu (TW)

(21) Appl. No.: 19/299,505

(22) Filed: Aug. 14, 2025

Related U.S. Application Data
(60) Provisional application No. 63/804,604, filed on May 12, 2025.

(51) Int. Cl. G06N 3/098; G06N 3/04

(52) U.S. Cl. CPC G06N 3/098; G06N 3/04

(57) ABSTRACT

In some implementations, the techniques described herein relate to a method including: receiving, by a controller node, a task request from a client device within a home network environment; querying, by the controller node, a global service registry to identify available edge nodes capable of executing artificial intelligence processing tasks; selecting, by the controller node, an optimal edge node from the available edge nodes based on current resource utilization and task requirements; establishing, by the controller node, a direct communication connection between the client device and the selected edge node; monitoring, by the controller node, execution of the artificial intelligence processing task on the selected edge node; and coordinating, by the controller node, federated learning parameter synchronization between the selected edge node and a cloud-based learning server.

### CROSS-REFERENCE TO RELATED APPLICATIONS

This application claims the benefit of priority from U.S. Provisional Application No. 63/804,604, filed May 19, 2025, whereby the contents of which are incorporated by reference in its entirety.

### BACKGROUND

Modern home networks have evolved significantly from simple internet connectivity providers to complex ecosystems supporting numerous connected devices. The typical household now contains dozens of wireless devices including smartphones, tablets, laptops, smart televisions, streaming devices, smart speakers, thermostats, security cameras, and various Internet of Things (IoT) sensors and appliances. This proliferation of connected devices has created substantial computational and networking demands within residential environments.

### BRIEF DESCRIPTION OF THE DRAWINGS

FIG. 1 is a block diagram illustrating a distributed artificial intelligence system for home networks according to some of the disclosed embodiments.

FIG. 2 is a block diagram illustrating the core architecture components of a distributed artificial intelligence system according to some of the disclosed embodiments.

FIG. 3 is a flow diagram illustrating a method for service registration and heartbeat management in a distributed artificial intelligence system according to some of the disclosed embodiments.

FIG. 4 is a flow diagram illustrating a method for task orchestration and distributed execution in a home network artificial intelligence system according to some of the disclosed embodiments.

FIG. 5 is a flow diagram illustrating a method for client service request processing in a distributed artificial intelligence system according to some of the disclosed embodiments.

FIG. 6 is a flow diagram illustrating a method for federated learning implementation in a distributed artificial intelligence system according to some of the disclosed embodiments.

FIG. 7 is a flow diagram illustrating a method for agentic artificial intelligence implementation and autonomous operation in a distributed home network system according to some of the disclosed embodiments.

FIG. 8 is a block diagram of a computing device according to some embodiments of the disclosure.

### DETAILED DESCRIPTION

Traditional home network architectures rely heavily on cloud-based services for processing intensive computational tasks, particularly those involving artificial intelligence (AI) and machine learning (ML) operations. In these conventional approaches, home devices typically function as simple clients that capture data locally but transmit it to remote cloud servers for analysis and processing. While cloud computing provides access to powerful computational resources, this architecture presents several limitations including network latency, bandwidth consumption, privacy concerns, and dependency on reliable internet connectivity.

The increasing adoption of artificial intelligence applications in consumer devices has further highlighted these architectural limitations. Modern AI applications often require real-time or near-real-time processing for optimal user experience, making cloud-based processing latencies problematic. Additionally, many AI applications involve processing of sensitive personal data such as images, audio recordings, and behavioral patterns, raising privacy concerns when this data must be transmitted to external cloud services.

Simultaneously, the computational capabilities of home network devices have increased substantially. Modern wireless access points, gateways, set-top boxes, and even mobile devices often include multi-core processors, substantial memory, and specialized processing units that remain underutilized during normal operation. However, existing network architectures lack mechanisms to effectively coordinate and leverage these distributed computational resources for collaborative processing tasks.

Current approaches to distributed computing in home environments typically rely on ad-hoc solutions or proprietary systems that lack standardized coordination mechanisms. These systems often suffer from poor resource utilization, limited scalability, and insufficient fault tolerance. Furthermore, existing solutions generally do not provide mechanisms for intelligent task distribution, dynamic load balancing, or coordinated learning across multiple devices.

The field of federated learning has emerged as a promising approach for distributed machine learning that preserves data privacy while enabling collaborative model training. However, existing federated learning implementations are primarily designed for data center environments or wide-area networks, with limited consideration for the unique characteristics and constraints of home network environments.

In sum, current home network architectures lack a comprehensive technical framework for coordinating and orchestrating artificial intelligence workloads across distributed edge computing resources within residential environments. Existing systems suffer from several critical technical limitations: (1) absence of standardized service discovery and resource management protocols that enable dynamic identification and allocation of computational capabilities across heterogeneous home devices; (2) lack of intelligent task distribution mechanisms that can decompose AI processing workloads and assign them to optimal computing nodes based on real-time resource availability and performance characteristics; (3) insufficient orchestration infrastructure for managing concurrent AI tasks, monitoring execution status, and implementing fault tolerance across distributed edge nodes; (4) absence of federated learning architectures specifically designed for home network constraints that enable collaborative model training while preserving data locality and privacy; and (5) lack of autonomous agent frameworks that can operate independently within resource-constrained edge environments while coordinating with distributed system components. These technical deficiencies result in inefficient utilization of available computational resources, suboptimal AI processing performance, and inability to leverage the collective intelligence of distributed home devices for enhanced AI capabilities.

Thus, there remains a need for comprehensive distributed computing architectures specifically designed for home network environments that can effectively coordinate computational resources, provide intelligent task orchestration, and enable privacy-preserving collaborative learning while maintaining the reliability and user experience expectations of residential users.

The disclosed technology addresses these technical limitations through a novel four-layer distributed AI architecture that provides comprehensive orchestration and coordination capabilities for home network environments. The system implements a hierarchical service registry architecture with both local and global components that enable real-time discovery and management of AI services and computational resources across heterogeneous edge devices. An intelligent task orchestration layer utilizes advanced scheduling algorithms and load balancing mechanisms to dynamically distribute AI workloads based on real-time resource monitoring and performance optimization criteria. The architecture incorporates a containerized AI infrastructure that provides elastic edge computing capabilities, enabling automatic scaling and migration of AI processing tasks across multiple nodes. A federated learning framework specifically designed for home network constraints implements privacy-preserving distributed training through parameter synchronization and differential privacy techniques while maintaining data locality. Additionally, the system includes an agentic AI controller that enables autonomous operation and decision-making within individual edge nodes while participating in coordinated distributed intelligence. This integrated technical approach enables efficient utilization of distributed computational resources, provides fault-tolerant AI processing capabilities, and creates a scalable framework for collaborative intelligence across home network devices.

In some implementations, the techniques described herein relate to a method including: receiving, by a controller node, a task request from a client device within a home network environment; querying, by the controller node, a global service registry to identify available edge nodes capable of executing artificial intelligence processing tasks; selecting, by the controller node, an optimal edge node from the available edge nodes based on current resource utilization and task requirements; establishing, by the controller node, a direct communication connection between the client device and the selected edge node; monitoring, by the controller node, execution of the artificial intelligence processing task on the selected edge node; and coordinating, by the controller node, federated learning parameter synchronization between the selected edge node and a cloud-based learning server.

In some implementations, the techniques described herein relate to a method, wherein querying the global service registry includes receiving real-time resource metrics from a plurality of local service registries distributed across edge nodes in the home network environment.

In some implementations, the techniques described herein relate to a method, wherein selecting the optimal edge node includes evaluating candidate nodes based on one or more of processor utilization, memory availability, artificial intelligence model compatibility, or network connectivity quality.

In some implementations, the techniques described herein relate to a method, wherein monitoring execution of the artificial intelligence processing task includes tracking task progress, resource consumption, and performance metrics in real-time.

In some implementations, the techniques described herein relate to a method, wherein coordinating federated learning parameter synchronization includes applying privacy filtering to model parameters before transmission to the cloud-based learning server.

In some implementations, the techniques described herein relate to a method, wherein the method further includes distributing the artificial intelligence processing task across multiple edge nodes when the selected edge node has insufficient computational capacity.

In some implementations, the techniques described herein relate to a method, wherein the client device includes one of a smartphone, tablet, smart TV, or IoT device.

In some implementations, the techniques described herein relate to a non-transitory computer-readable storage medium for tangibly storing computer program instructions capable of being executed by a computer processor, the computer program instructions defining steps of: receiving, by a controller node, a task request from a client device within a home network environment; querying, by the controller node, a global service registry to identify available edge nodes capable of executing artificial intelligence processing tasks; selecting, by the controller node, an optimal edge node from the available edge nodes based on current resource utilization and task requirements; establishing, by the controller node, a direct communication connection between the client device and the selected edge node; monitoring, by the controller node, execution of the artificial intelligence processing task on the selected edge node; and coordinating, by the controller node, federated learning parameter synchronization between the selected edge node and a cloud-based learning server.

In some implementations, the techniques described herein relate to a non-transitory computer-readable storage medium, wherein querying the global service registry includes receiving real-time resource metrics from a plurality of local service registries distributed across edge nodes in the home network environment.

In some implementations, the techniques described herein relate to a non-transitory computer-readable storage medium, wherein selecting the optimal edge node includes evaluating candidate nodes based on one or more of processor utilization, memory availability, artificial intelligence model compatibility, or network connectivity quality.

In some implementations, the techniques described herein relate to a non-transitory computer-readable storage medium, wherein monitoring execution of the artificial intelligence processing task includes tracking task progress, resource consumption, and performance metrics in real-time.

In some implementations, the techniques described herein relate to a non-transitory computer-readable storage medium, wherein coordinating federated learning parameter synchronization includes applying privacy filtering to model parameters before transmission to the cloud-based learning server.

In some implementations, the techniques described herein relate to a non-transitory computer-readable storage medium, wherein the steps further include distributing the artificial intelligence processing task across multiple edge nodes when the selected edge node has insufficient computational capacity.

In some implementations, the techniques described herein relate to a non-transitory computer-readable storage medium, wherein the client device includes one of a smartphone, tablet, smart TV, or IoT device.

In some implementations, the techniques described herein relate to a device including: a processor; a non-transitory computer-readable medium storing program instructions that, when executed by the processor, causes the processor to perform operations of: receiving a task request from a client device within a home network environment; querying a global service registry to identify available edge nodes capable of executing artificial intelligence processing tasks; selecting an optimal edge node from the available edge nodes based on current resource utilization and task requirements; establishing a direct communication connection between the client device and the selected edge node; monitoring execution of the artificial intelligence processing task on the selected edge node; and coordinating federated learning parameter synchronization between the selected edge node and a cloud-based learning server.

In some implementations, the techniques described herein relate to a device, wherein querying the global service registry includes receiving real-time resource metrics from a plurality of local service registries distributed across edge nodes in the home network environment.

In some implementations, the techniques described herein relate to a device, wherein selecting the optimal edge node includes evaluating candidate nodes based on one or more of processor utilization, memory availability, artificial intelligence model compatibility, or network connectivity quality.

In some implementations, the techniques described herein relate to a device, wherein monitoring execution of the artificial intelligence processing task includes tracking task progress, resource consumption, and performance metrics in real-time.

In some implementations, the techniques described herein relate to a device, wherein coordinating federated learning parameter synchronization includes applying privacy filtering to model parameters before transmission to the cloud-based learning server.

In some implementations, the techniques described herein relate to a device, wherein the operations further include distributing the artificial intelligence processing task across multiple edge nodes when the selected edge node has insufficient computational capacity.

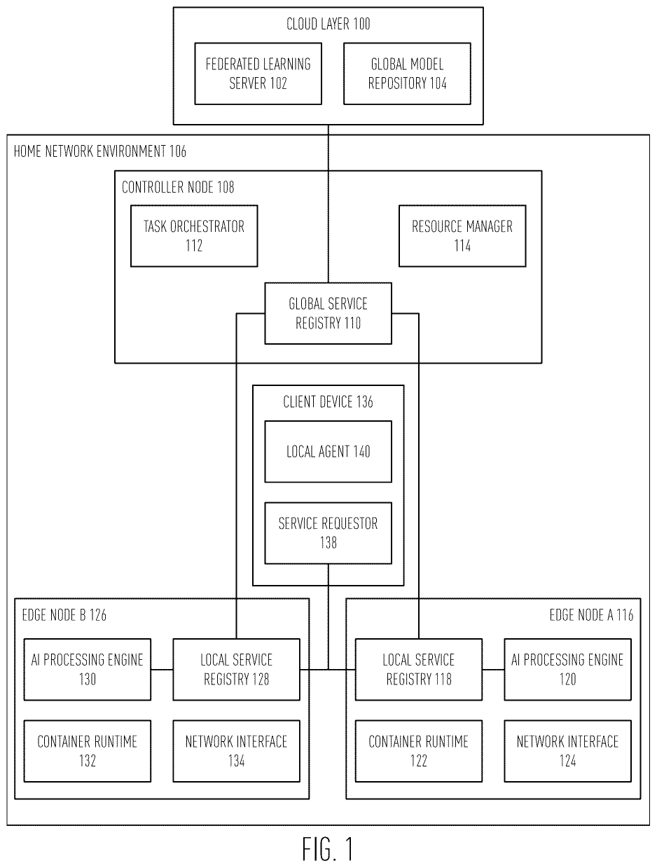

FIG. 1 is a block diagram illustrating a distributed AI system for home networks according to some of the disclosed embodiments.

In the illustrated embodiment, a distributed AI system includes a cloud layer 100 and a home network environment 106. The cloud layer 100 is communicatively coupled to components within the home network environment 106 to provide federated learning capabilities and global model management, among other features. The home network environment 106 comprises multiple interconnected nodes that collectively form a distributed computing infrastructure capable of executing AI workloads locally while maintaining coordination with cloud-based services, as will be discussed in more detail herein.

The cloud layer 100 includes a federated learning server 102 and a global model repository 104. The federated learning server 102 is configured to aggregate learning parameters from multiple home network environments and update global AI models based on distributed training data. In some implementations, the federated learning server 102 receives model parameters, training insights, and performance metrics from home networks while preserving privacy by avoiding direct access to raw user data. The global model repository 104 stores updated AI models, training algorithms, and configuration parameters that can be distributed to participating home networks. In some implementations, the global model repository 104 maintains versioned models and enables selective deployment of model updates based on specific home network requirements or capabilities.

Within the home network environment 106, a controller node 108 serves as the central coordination point for distributed AI operations. The controller node 108 includes inter alia a global service registry 110, a task orchestrator 112, and a resource manager 114. These components work in concert to manage the distributed AI infrastructure and coordinate task execution across multiple edge nodes within the home environment.

The global service registry 110 maintains a comprehensive catalog of available AI services, computational resources, and capabilities across all nodes in the home network. In some implementations, the global service registry 110 receives periodic updates from local service registries on edge nodes and maintains real-time awareness of system capacity, service availability, and node health status. The global service registry 110 may store information including, without limitation, available AI models, processing capabilities, memory resources, and current load status for each participating node. In some implementations, the global service registry 110 can respond to service discovery requests from client devices by providing lists of suitable nodes capable of handling specific AI processing tasks.

The task orchestrator 112 is responsible for intelligent distribution of AI workloads across available edge nodes. In some implementations, the task orchestrator 112 receives task requests from client devices, evaluates resource requirements, and selects optimal nodes for task execution based on current system state and performance objectives. The task orchestrator 112 may implement load balancing algorithms to distribute workloads evenly across available nodes or may prioritize certain nodes based on their specialized capabilities or proximity to requesting devices. In some implementations, the task orchestrator 112 can decompose complex AI tasks into smaller subtasks that can be executed in parallel across multiple edge nodes, thereby reducing overall processing time and improving system responsiveness.

The resource manager 114 continuously monitors the computational resources and health status of all nodes within the home network. In some implementations, the resource manager 114 tracks CPU utilization, memory consumption, storage availability, and network bandwidth for each connected node. The resource manager 114 may implement predictive algorithms to anticipate resource bottlenecks and proactively redistribute workloads to maintain optimal system performance. In some implementations, the resource manager 114 can trigger automated scaling operations, such as activating additional nodes or migrating tasks between nodes, based on changing demand patterns or node failures.

The home network environment 106 includes multiple edge nodes, illustrated as edge node A 116 and edge node B 126, though additional nodes may be present in actual implementations. Each edge node represents a computing device capable of executing AI workloads locally, such as wireless access points, gateways, set-top boxes, or other network-connected devices with sufficient computational capabilities.

As illustrated, edge node A 116 includes a local service registry 118, an AI processing engine 120, a container runtime 122, and a network interface 124. Similarly, edge node B 126 includes corresponding components: a local service registry 128, an AI processing engine 130, a container runtime 132, and a network interface 134. This modular architecture enables consistent functionality across heterogeneous hardware platforms while allowing for device-specific optimizations.

Local service registry 118 and local service registry 128 maintain detailed information about the capabilities and current status of their respective nodes. In some implementations, each local service registry collects resource utilization metrics, available AI models, supported service types, and current task loads. The local service registries periodically communicate this information to the global service registry 110 to maintain system-wide awareness of available resources. In some implementations, local service registries can also cache information about other nodes in the system to enable direct peer-to-peer communication and reduce dependency on the central controller for routine operations.

AI processing engine 120 and AI processing engine 130 execute machine learning models and AI algorithms on their respective nodes. In some implementations, these engines can load and execute various types of AI models, including computer vision models, natural language processing models, and specialized domain-specific algorithms. The AI processing engines may support multiple concurrent model executions and can dynamically load or unload models based on current demand. In some implementations, the AI processing engines include optimization features such as model quantization, pruning, or hardware-specific acceleration to maximize performance on edge devices with limited computational resources.

Container runtime 122 and container runtime 132 provide isolated execution environments for AI applications and services. In some implementations, these runtimes support standard containerization technologies such as Linux containers (LXC) or similar lightweight virtualization approaches. The container runtimes enable portable deployment of AI applications across different hardware platforms and provide security isolation between different AI workloads executing on the same node. In some implementations, the container runtimes include lifecycle management capabilities for automatically starting, stopping, and updating containerized AI services based on system demands or administrator policies.

Network interface 124 and network interface 134 enable communication between edge nodes, the controller node, and external networks. In some implementations, these interfaces support multiple communication protocols and can establish both local network connections for intra-home communication and internet connections for cloud integration. The network interfaces may implement quality-of-service features to prioritize AI-related traffic and ensure reliable communication for time-sensitive applications.

The client device 136 represents any device within the home network that requires AI processing services, such as a set-top box, smartphone, tablet, smart TV, IoT device, camera, access point, or similar networked computing device. The client device 136 includes a service requestor 138 and a local agent 140. The service requestor 138 generates requests for AI services and coordinates with the global service registry 110 to discover available processing nodes. In some implementations, the service requestor 138 can communicate directly with selected edge nodes to submit tasks and receive results, bypassing the central controller for improved performance and reduced latency.

The local agent 140 provides device-specific functionality for integrating with the distributed AI system. In some implementations, the local agent 140 handles authentication, encryption, and protocol translation to enable seamless communication with the distributed infrastructure. The local agent 140 may also implement local caching mechanisms to store frequently used AI models or results, reducing network traffic and improving response times for repeated requests.

The illustrated communication paths show the interconnected nature of the system. The cloud layer 100 communicates bidirectionally with the global service registry 110 to exchange model updates, learning parameters, and system telemetry. Within the home network, the global service registry 110 maintains connections with both local service registries and the service requestor 138. The local service registries are coupled to their respective AI processing engines to coordinate local task execution. Additionally, the service requestor 138 can establish direct connections with edge nodes for efficient task submission and result retrieval.

This distributed architecture enables the system to leverage both local computational resources and cloud-based intelligence while maintaining privacy, reducing latency, and providing resilient operation even during network outages or cloud service disruptions.

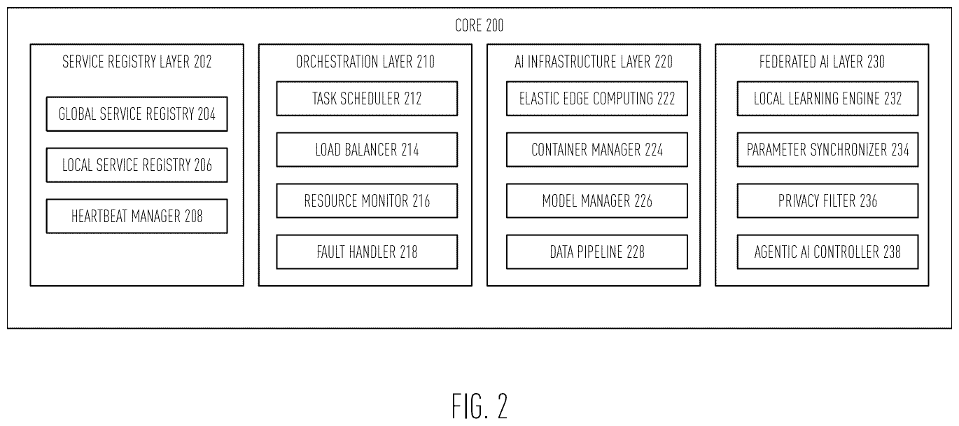

FIG. 2 is a block diagram illustrating the core architecture components of a distributed artificial intelligence system according to some of the disclosed embodiments.

In the illustrated embodiment, the core architecture 200 comprises four distinct but interconnected layers that collectively enable distributed AI processing across home network environments. These layers work in hierarchical coordination to provide comprehensive AI services while maintaining system reliability, performance optimization, and privacy protection. The layered architecture enables modular deployment and independent scaling of different system capabilities based on specific deployment requirements or hardware constraints.

The service registry layer 202 forms the foundational communication and discovery infrastructure for the distributed system. This layer includes a global service registry 204, a local service registry 206, and a heartbeat manager 208. These components work together to maintain real-time awareness of system topology, service availability, and node health across the entire distributed infrastructure.

The global service registry 204 serves as the central authority for service discovery and node coordination within the home network environment. In some implementations, the global service registry 204 maintains a comprehensive catalog of all available AI services, computational capabilities, and resource capacities across participating nodes. The global service registry 204 may store detailed metadata including, without limitation, supported AI model types, processing speeds, memory limitations, and current availability status for each registered node. In some implementations, the global service registry 204 implements intelligent caching mechanisms to reduce lookup latency and provides load-aware service recommendations to optimize task distribution across available resources.

The local service registry 206 operates on individual edge nodes to collect and report local capabilities and status information. In some implementations, each local service registry 206 continuously monitors its host node's computational resources, installed AI models, active services, and current workload. The local service registry 206 may implement adaptive reporting algorithms that increase update frequency during periods of high activity or resource changes while reducing communication overhead during stable operation periods. In some implementations, the local service registry 206 can cache information about peer nodes to enable direct node-to-node communication for improved performance and reduced dependency on centralized coordination.

The heartbeat manager 208 ensures system reliability by monitoring the health and availability of all participating nodes. In some implementations, the heartbeat manager 208 implements configurable monitoring intervals and timeout thresholds to detect node failures or network partitions. The heartbeat manager 208 may employ multiple detection mechanisms including, without limitation, periodic ping messages, resource utilization reports, and service response time monitoring. In some implementations, the heartbeat manager 208 can trigger automated recovery procedures such as task migration, service restart, or alternative node activation when failures are detected.

The orchestration layer 210 provides intelligent coordination and management of AI workloads across the distributed infrastructure. This layer includes a task scheduler 212, a load balancer 214, a resource monitor 216, and a fault handler 218. These components collectively ensure optimal utilization of available resources while maintaining system stability and performance.

The task scheduler 212 receives AI processing requests and determines optimal execution strategies based on current system state and task requirements. In some implementations, the task scheduler 212 evaluates factors including computational complexity, data locality, deadline requirements, and resource availability when making scheduling decisions. The task scheduler 212 may implement multiple scheduling algorithms such as round-robin, priority-based, or machine learning-driven approaches to optimize different performance metrics. In some implementations, the task scheduler 212 can decompose complex AI tasks into smaller subtasks that can be executed in parallel across multiple nodes, enabling improved throughput and reduced processing latency.

The load balancer 214 distributes workloads evenly across available computational resources to prevent bottlenecks and maximize system throughput. In some implementations, the load balancer 214 monitors real-time resource utilization across all nodes and implements dynamic load redistribution algorithms to maintain optimal performance. The load balancer 214 may consider multiple factors including CPU utilization, memory consumption, network bandwidth, and historical performance patterns when making load distribution decisions. In some implementations, the load balancer 214 can predict future resource demands based on usage patterns and proactively adjust load distribution to prevent performance degradation.

The resource monitor 216 continuously tracks computational resources and performance metrics across the distributed system. In some implementations, the resource monitor 216 collects detailed telemetry data including processor utilization, memory consumption, storage availability, network latency, and task completion rates. The resource monitor 216 may implement statistical analysis and trend detection algorithms to identify performance anomalies or capacity limitations. In some implementations, the resource monitor 216 provides real-time dashboards and alerting capabilities to enable proactive system management and optimization.

The fault handler 218 detects and responds to various types of system failures or performance degradations. In some implementations, the fault handler 218 monitors for node failures, network partitions, resource exhaustion, and application errors. The fault handler 218 may implement multiple recovery strategies including task migration, service restart, alternative node activation, or graceful degradation depending on the nature and severity of detected faults. In some implementations, the fault handler 218 can learn from historical failure patterns to improve fault prediction and prevention capabilities.

The AI infrastructure layer 220 provides the core computational and deployment capabilities for AI applications. This layer includes elastic edge computing 222, a container manager 224, a model manager 226, and a data pipeline 228. These components enable flexible and scalable deployment of AI workloads across heterogeneous edge devices.

The elastic edge computing 222 provides dynamic scaling and resource allocation capabilities for AI workloads. In some implementations, elastic edge computing 222 can automatically provision additional computational resources during periods of high demand and release resources during low utilization periods. The elastic edge computing 222 may implement algorithms to predict resource demands and preemptively scale resources to maintain consistent performance. In some implementations, elastic edge computing 222 supports migration of running AI tasks between nodes to optimize resource utilization or respond to changing system conditions.

The container manager 224 provides isolated execution environments for AI applications and manages the lifecycle of containerized services. In some implementations, the container manager 224 supports standard containerization technologies and provides features including automatic deployment, scaling, and update management. The container manager 224 may implement security policies to ensure proper isolation between different AI workloads and enforce resource limits to prevent individual applications from consuming excessive system resources. In some implementations, the container manager 224 can optimize container placement based on hardware capabilities and performance requirements.

The model manager 226 handles the storage, versioning, and deployment of AI models across the distributed infrastructure. In some implementations, the model manager 226 maintains a local cache of frequently used models and implements intelligent prefetching algorithms to reduce model loading latency. The model manager 226 may support multiple model formats and can perform automatic optimization such as quantization or pruning to improve performance on resource-constrained edge devices. In some implementations, the model manager 226 coordinates with the federated learning system to deploy updated models and manage model versioning across participating nodes.

The data pipeline 228 manages the flow of training and inference data throughout the system while ensuring privacy and security. In some implementations, the data pipeline 228 implements data preprocessing, normalization, and transformation capabilities to prepare data for AI model consumption. The data pipeline 228 may include compression and encryption features to optimize network utilization and protect sensitive information during data transmission. In some implementations, the data pipeline 228 supports streaming data processing and can handle both batch and real-time data processing requirements.

The federated AI layer 230 enables distributed learning and autonomous AI capabilities while preserving privacy. This layer includes a local learning engine 232, a parameter synchronizer 234, a privacy filter 236, and an agentic AI controller 238. These components collectively enable the system to learn and adapt while maintaining user privacy and providing autonomous operation capabilities.

The local learning engine 232 performs AI model training using locally available data without transmitting raw data to external systems. In some implementations, the local learning engine 232 supports various machine learning algorithms including supervised learning, unsupervised learning, and reinforcement learning approaches. The local learning engine 232 may implement incremental learning techniques to continuously improve model performance based on new data while minimizing computational overhead. In some implementations, the local learning engine 232 can adapt learning algorithms based on local data characteristics and hardware capabilities to optimize training efficiency.

The parameter synchronizer 234 coordinates the sharing of model parameters and learning insights across multiple nodes while preserving data privacy. In some implementations, the parameter synchronizer 234 implements federated learning protocols that aggregate model updates from multiple nodes without exposing individual training data. The parameter synchronizer 234 may use differential privacy techniques and secure aggregation methods to ensure that shared parameters do not reveal sensitive information about local datasets. In some implementations, the parameter synchronizer 234 can selectively share parameters based on relevance and quality metrics to improve overall system learning efficiency.

The privacy filter 236 ensures that sensitive information is protected during data sharing and model synchronization operations. In some implementations, the privacy filter 236 implements multiple privacy-preserving techniques including data anonymization, differential privacy, and homomorphic encryption. The privacy filter 236 may analyze data and model parameters to identify potentially sensitive information and apply appropriate protection mechanisms before sharing. In some implementations, the privacy filter 236 can be configured with user-defined privacy policies and can adapt protection levels based on data sensitivity classifications.

The agentic AI controller 238 enables autonomous operation and decision-making capabilities within the distributed system. In some implementations, the agentic AI controller 238 can autonomously optimize system performance, respond to changing conditions, and make decisions without human intervention. The agentic AI controller 238 may implement goal-oriented planning algorithms and can coordinate with other system components to achieve desired outcomes. In some implementations, the agentic AI controller 238 can learn from system behavior and user preferences to improve autonomous decision-making over time.

The illustrated connections between components show the hierarchical and interdependent nature of the architecture, enabling coordinated operation while maintaining clear separation of concerns across different functional layers.

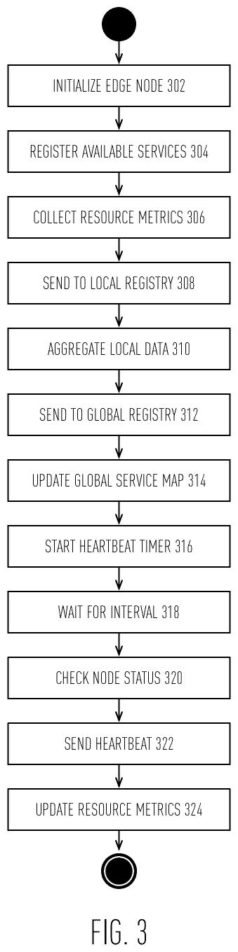

FIG. 3 is a flow diagram illustrating a method for service registration and heartbeat management in a distributed artificial intelligence system according to some of the disclosed embodiments.

In step 302, the method includes initializing an edge node within the distributed AI infrastructure.

In some implementations, the edge node initialization process involves establishing the foundational software and hardware configurations necessary for participation in the distributed AI network. The initialization process may include loading essential system drivers, establishing network connectivity, and verifying hardware capabilities such as processor specifications, available memory, and storage capacity. In some implementations, the edge node may comprise various types of devices including, without limitation, wireless access points, gateways, set-top boxes, smart home devices, or other network-connected computing devices with sufficient computational resources to execute AI workloads.

In some implementations, the initialization process includes establishing secure communication channels with other nodes in the network through cryptographic key exchange and authentication protocols. The edge node may generate or receive unique identifiers that will be used throughout its participation in the distributed system. In some implementations, the initialization process includes loading configuration parameters specific to the home network environment, such as network topology information, security policies, and performance optimization settings. The edge node may also perform self-diagnostic tests to verify that all subsystems are functioning correctly and are capable of supporting AI processing tasks.

In step 304, the method includes registering available services with the local service infrastructure.

In some implementations, the service registration process involves cataloging all AI capabilities, computational resources, and specialized functions that the edge node can provide to the distributed system. The available services may include various types of AI models such as computer vision models for image processing, natural language processing models for text analysis, audio processing models for voice recognition, and domain-specific models for specialized applications. In some implementations, the registration process includes detailed capability assessment where the edge node evaluates its hardware specifications and determines which AI models can be effectively executed given memory constraints, processing power limitations, and thermal considerations.

In some implementations, the edge node may dynamically discover available services by scanning for installed AI model files, examining containerized applications, and querying software libraries for supported functionality. The service registration process may include performance benchmarking where the edge node executes sample AI tasks to measure throughput, latency, and resource consumption for different types of workloads. In some implementations, the registration includes specifying service-level agreements such as expected response times, quality metrics, and availability guarantees that the edge node can commit to providing.

In some implementations, the service registration process may be hierarchical, where basic services are registered first followed by more complex composite services that depend on the availability of foundational capabilities. The edge node may register both synchronous services that provide immediate responses and asynchronous services that can handle long-running or batch processing tasks. In some implementations, the registration includes metadata about service dependencies, resource requirements, and compatibility constraints that help the orchestration system make intelligent task assignment decisions.

In step 306, the method includes collecting comprehensive resource metrics from the edge node.

In some implementations, the resource metric collection process involves systematic monitoring of computational resources, system performance indicators, and operational status across multiple dimensions. The collected metrics may include processor utilization statistics such as CPU usage percentages, core-specific loading, and thermal status to ensure optimal performance without overheating. Memory metrics may include available RAM, memory allocation patterns, swap usage, and memory fragmentation statistics that impact AI model loading and execution efficiency.

In some implementations, storage metrics encompass available disk space, read/write performance characteristics, and storage device health indicators that affect the node's ability to cache AI models and store temporary processing data. Network performance metrics may include bandwidth utilization, latency measurements to other nodes, packet loss rates, and connection stability indicators that influence the node's effectiveness in collaborative processing scenarios. In some implementations, the metric collection includes AI-specific performance indicators such as model inference speeds, concurrent task capacity, and specialized hardware utilization rates for components like graphics processing units or neural processing units.

In some implementations, the resource metric collection process may employ adaptive sampling rates that increase monitoring frequency during periods of high activity or resource stress while reducing overhead during stable operation. The metrics collection system may implement statistical analysis to identify trends, detect anomalies, and predict future resource requirements based on historical usage patterns. In some implementations, the collection process includes environmental metrics such as device temperature, power consumption, and network connectivity quality that affect long-term system reliability and performance.

In step 308, the method includes transmitting the collected information to the local service registry.

In some implementations, the local service registry serves as an intermediary aggregation point that consolidates service capabilities and resource status information from multiple sources within the edge node before communicating with the broader distributed system. The transmission to the local registry may utilize data serialization formats and compression techniques to minimize network overhead while ensuring data integrity and completeness.

In some implementations, the local service registry implements filtering and aggregation algorithms that process raw metric data to extract meaningful insights and reduce information volume. The registry may perform statistical analysis to identify significant changes in resource availability or service capability that warrant immediate attention from the global coordination system. In some implementations, the local registry maintains historical data to enable trend analysis and predictive modeling that can anticipate future resource requirements or potential system bottlenecks.

In step 310, the method includes aggregating local data within the edge node's service registry.

In some implementations, the aggregation process involves combining information from multiple sources within the edge node to create a comprehensive representation of the node's current capabilities and status. The local service registry may correlate resource metrics with service availability to provide realistic assessments of the node's capacity to handle different types of AI workloads. In some implementations, the aggregation includes temporal analysis that considers recent performance history to provide more accurate predictions of future capabilities.

In some implementations, the aggregation process implements data quality assurance mechanisms that validate metric consistency, detect measurement errors, and filter out transient anomalies that might misrepresent the node's true capabilities. The local registry may apply machine learning algorithms to identify patterns in resource usage and service demand that enable more intelligent resource allocation and capacity planning. In some implementations, the aggregation includes synthesis of complex metrics that combine multiple basic measurements to provide higher-level indicators of system health and performance.

In step 312, the method includes sending aggregated information to the global service registry.

In some implementations, the transmission to the global service registry represents the edge node's formal communication of its current status and capabilities to the distributed system's central coordination infrastructure. The communication protocol may implement error handling, automatic retry mechanisms, and acknowledgment systems to ensure reliable delivery of critical status information. In some implementations, the transmission includes security measures such as message authentication, encryption, and integrity verification to protect sensitive system information during network transit.

In some implementations, the global communication may utilize adaptive transmission strategies that adjust message frequency and content based on network conditions, system load, and the significance of status changes. The edge node may implement intelligent batching algorithms that combine multiple updates into single transmissions to improve network efficiency while maintaining timely delivery of critical information. In some implementations, the transmission includes priority mechanisms that ensure urgent status updates such as fault conditions or capacity changes are communicated immediately while routine updates may be delayed or aggregated.

In step 314, the method includes updating the global service map maintained by the central coordination system.

In some implementations, the global service map represents a comprehensive real-time view of all available AI services, computational resources, and operational status across the entire distributed infrastructure. The update process involves integrating new information from the edge node with existing system knowledge to maintain accurate and current awareness of total system capabilities. In some implementations, the global service map implements sophisticated data structures and indexing mechanisms that enable efficient querying and resource discovery across large numbers of participating nodes.

In some implementations, the update process includes conflict resolution algorithms that handle situations where multiple nodes report conflicting information or where network delays result in out-of-order message delivery. The global service map may implement versioning and consistency mechanisms that ensure all system components operate with coherent views of resource availability and service capabilities. In some implementations, the update process triggers automated optimization algorithms that analyze the updated system state and recommend task redistribution or resource reallocation to improve overall system performance.

In step 316, the method includes starting a heartbeat timer mechanism for ongoing system monitoring.

In some implementations, the heartbeat timer establishes a regular communication schedule that ensures continuous monitoring of edge node health and availability throughout system operation. The timer configuration may be adaptive, adjusting heartbeat frequency based on system load, network conditions, and the criticality of the edge node's role in current processing tasks. In some implementations, the heartbeat system implements multiple timer mechanisms with different frequencies for various types of status information, enabling efficient communication of different data types with appropriate urgency levels.

In step 318, the method includes waiting for the configured heartbeat interval.

In some implementations, the waiting period represents an optimized balance between maintaining current system awareness and minimizing communication overhead that could interfere with productive AI processing tasks. The interval duration may be dynamically adjusted based on system conditions, with shorter intervals during periods of high activity or instability and longer intervals during stable operation. In some implementations, the waiting mechanism includes interrupt capabilities that allow immediate communication of critical status changes without waiting for the regular heartbeat schedule.

In step 320, the method includes checking the current status of the edge node.

In some implementations, the status check involves comprehensive evaluation of all monitored parameters to detect any changes in capability, performance, or operational conditions since the previous heartbeat cycle. The status evaluation may include comparison with baseline performance metrics to identify degradation or improvement in system capabilities. In some implementations, the status check includes predictive analysis that anticipates potential issues based on trend analysis of historical performance data.

In step 322, the method includes sending the heartbeat message to maintain system connectivity.

In some implementations, the heartbeat transmission includes current status summaries, performance metrics, and any significant changes in service availability or resource capacity. The heartbeat message format may be optimized for minimal network overhead while providing sufficient information for effective system coordination. In some implementations, the heartbeat system includes escalation mechanisms that trigger more detailed status reports when anomalies or significant changes are detected.

In step 324, the method includes updating resource metrics based on current system conditions.

In some implementations, the metric update process ensures that the edge node maintains accurate self-awareness of its capabilities and can provide reliable information to the distributed coordination system. The update mechanism may implement continuous monitoring that captures real-time changes in system performance and resource availability. In some implementations, the update process includes machine learning algorithms that improve metric accuracy and prediction capabilities over time based on observed system behavior and performance patterns.

In some implementations, the method can return to step 318 to continue the monitoring cycle, creating a continuous feedback loop that maintains system awareness and enables dynamic optimization of the distributed AI infrastructure. This cyclical process ensures that the distributed system can adapt to changing conditions, optimize resource utilization, and maintain reliable operation across all participating edge nodes.

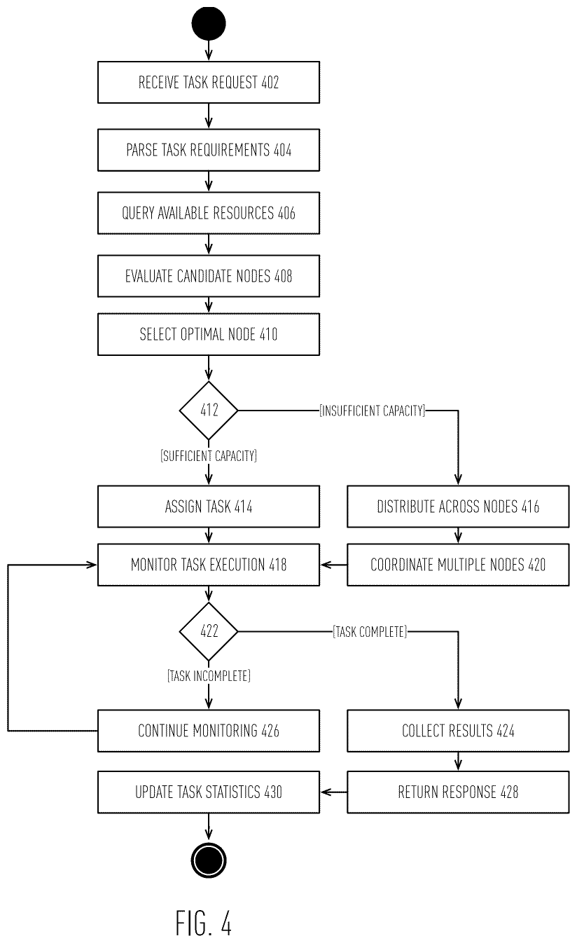

FIG. 4 is a flow diagram illustrating a method for task orchestration and distributed execution in a home network artificial intelligence system according to some of the disclosed embodiments.

In step 402, the method includes receiving a task request from a client device within the distributed AI infrastructure.

In some implementations, the task request may originate from various types of client devices including smartphones, tablets, smart televisions, IoT sensors, or other network-connected devices that require AI processing capabilities beyond their local computational resources. The task request typically includes detailed specifications of the required AI processing operation, such as image recognition, natural language processing, audio analysis, or specialized domain-specific computations. In some implementations, the request includes metadata specifying performance requirements such as maximum acceptable latency, desired accuracy levels, and priority classifications that influence scheduling decisions.

In some implementations, the task request may include data payload information such as image files, audio streams, text documents, or sensor readings that require processing, along with format specifications and size parameters that affect resource allocation decisions. The request mechanism may implement secure transmission protocols with authentication and encryption to protect sensitive data during transfer. In some implementations, the orchestration system maintains request queues with priority handling capabilities that ensure critical tasks receive preferential treatment while maintaining fair resource allocation across multiple concurrent requests.

In step 404, the method includes parsing the task requirements to extract essential processing parameters.

In some implementations, the parsing process involves detailed analysis of the task specification to identify the type of AI model required, computational complexity estimates, memory requirements, and expected processing duration. The parsing mechanism may implement intelligent classification algorithms that categorize incoming requests based on their processing characteristics and resource demands. In some implementations, the parsing includes validation checks that verify the task specification is complete, consistent, and feasible given the current system capabilities.

In some implementations, the requirement parsing may involve decomposition of complex tasks into smaller subtasks that can be processed independently or in parallel across multiple nodes. The parsing process may include dependency analysis that identifies relationships between different components of the task and determines optimal execution sequences. In some implementations, the parsing mechanism includes estimation algorithms that predict resource consumption and processing time based on historical performance data and task characteristics.

In step 406, the method includes querying available resources across the distributed node infrastructure.

In some implementations, the resource query process involves real-time interrogation of the global service registry to obtain current status information for all participating edge nodes in the home network. The query mechanism may implement intelligent filtering that identifies nodes with appropriate capabilities for the specific task requirements while considering current load conditions and availability status. In some implementations, the query includes performance prediction algorithms that estimate expected task completion times and resource utilization based on current node conditions.

In some implementations, the resource query may involve multi-dimensional analysis considering factors such as computational capacity, memory availability, network connectivity quality, and specialized hardware capabilities like graphics processing units or neural processing units. The query process may implement caching mechanisms that maintain recently updated resource information to reduce query latency and network overhead. In some implementations, the query includes geographic or network topology considerations that favor nodes with optimal connectivity to the requesting client device.

In step 408, the method includes evaluating candidate nodes to determine suitability for task execution.

In some implementations, the evaluation process involves comprehensive analysis of multiple factors including current resource utilization, historical performance metrics, reliability indicators, and compatibility with the specific task requirements. The evaluation mechanism may implement scoring algorithms that assign numerical ratings to candidate nodes based on weighted combinations of relevant criteria. In some implementations, the evaluation includes predictive modeling that anticipates how task assignment will affect overall system performance and resource distribution.

In some implementations, the node evaluation process may consider specialized capabilities such as optimized AI accelerators, pre-loaded model libraries, or domain-specific processing expertise that could significantly improve task execution efficiency. The evaluation mechanism may implement machine learning algorithms that improve selection accuracy over time based on observed performance outcomes and user satisfaction metrics. In some implementations, the evaluation includes risk assessment that considers node reliability history and fault tolerance characteristics when making assignment decisions.

In step 410, the method includes selecting the optimal node configuration for task execution.

In some implementations, the selection process implements optimization algorithms that identify the best possible resource allocation considering multiple objectives such as minimizing execution time, balancing system load, and maximizing overall system throughput. The selection mechanism may employ various optimization strategies including greedy algorithms for rapid decision-making or more sophisticated approaches like genetic algorithms for complex multi-objective optimization. In some implementations, the selection process includes scenario analysis that evaluates multiple potential assignments and selects the configuration with the highest expected performance.

In step 412, the method includes checking whether the selected node has sufficient capacity for the requested task.

In some implementations, the capacity check involves detailed analysis of current resource utilization compared to the estimated requirements of the incoming task to ensure successful execution without degrading existing workloads. The capacity assessment may include memory availability checks, processor utilization analysis, and bandwidth availability verification. In some implementations, the capacity check includes safety margins that prevent over-allocation and maintain system stability even during peak demand periods.

If sufficient capacity is available, the method proceeds to step 414 to assign the task to the selected node. In some implementations, the task assignment involves detailed communication of task parameters, data transfer coordination, and establishment of monitoring connections between the orchestrator and the executing node. The assignment process may include resource reservation mechanisms that ensure the allocated capacity remains available throughout task execution.

If capacity is insufficient, the method proceeds to step 416 to distribute the task across multiple nodes. In some implementations, the distribution process involves intelligent task decomposition that divides the workload into smaller components that can be processed in parallel across multiple edge nodes. The distribution mechanism may implement load balancing algorithms that optimize resource utilization while minimizing communication overhead between distributed components.

In step 418, the method includes monitoring task execution to ensure successful completion and optimal performance.

In some implementations, the monitoring process involves continuous tracking of execution progress, resource utilization, and performance metrics to detect potential issues and optimize ongoing operations. The monitoring mechanism may implement real-time alerting systems that notify the orchestrator of execution anomalies, resource bottlenecks, or completion delays. In some implementations, the monitoring includes adaptive optimization that can adjust resource allocation or execution parameters during task processing to improve performance or respond to changing system conditions.

When task distribution is required, step 420 includes coordinating multiple nodes to ensure synchronized and efficient parallel processing. In some implementations, the coordination process involves establishing communication channels between participating nodes, synchronizing execution timelines, and managing data dependencies between distributed task components.

In step 422, the method includes checking whether task execution has completed successfully. This verification process may involve validation of output quality, confirmation of successful data processing, and verification that all distributed components have finished their assigned work.

If execution is not complete, the method continues monitoring in step 426, maintaining oversight until successful completion. If execution is complete, the method proceeds to step 424 to collect results from the executing node or nodes.

In step 428, the method includes returning the processed results to the requesting client device, completing the service delivery cycle. Finally, in step 430, the method includes updating task execution statistics and performance metrics to improve future orchestration decisions and system optimization.

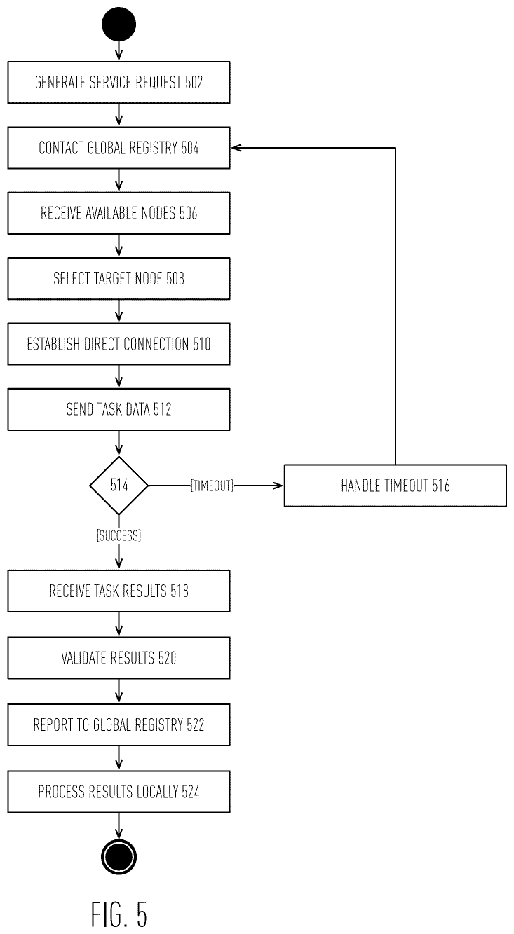

FIG. 5 is a flow diagram illustrating a method for client service request processing in a distributed artificial intelligence system according to some of the disclosed embodiments.

In step 502, the method includes generating a service request from a client device within the home network infrastructure.

In some implementations, the service request generation process involves the client device identifying a computational task that exceeds its local processing capabilities and requires distributed AI resources for efficient execution. The request generation may be triggered by various scenarios including image processing tasks that demand specialized computer vision models, natural language processing operations requiring large language models, or real-time analytics that benefit from parallel processing across multiple nodes. In some implementations, the client device may comprise resource-constrained devices such as smart cameras, IoT sensors, mobile devices, or set-top boxes that lack sufficient computational power, memory, or specialized AI accelerators to perform complex machine learning operations locally.

In some implementations, the service request includes detailed specification of the required AI processing operation, including model type requirements, input data characteristics, performance constraints, and quality expectations. The request generation process may implement intelligent preprocessing that optimizes data format, applies compression techniques, or performs initial filtering to reduce network transmission overhead and improve processing efficiency. In some implementations, the request includes priority indicators, deadline requirements, and service-level preferences that influence how the distributed system handles the task assignment and execution scheduling.

In step 504, the method includes contacting the global service registry to discover available processing resources.

In some implementations, the global service registry serves as the central coordination point that maintains comprehensive real-time awareness of all available AI services, computational capabilities, and current resource utilization across the distributed home network infrastructure. The contact mechanism may implement efficient communication protocols that minimize latency and network overhead while ensuring reliable delivery of service discovery requests. In some implementations, the client device may maintain cached authentication credentials and communication parameters that enable rapid connection establishment with the global registry without repetitive authentication overhead.

In some implementations, the registry contact process includes transmission of detailed task requirements that enable the global service registry to perform intelligent resource matching and recommendation. The communication may include security mechanisms such as encrypted transmission, message authentication, and integrity verification to protect sensitive task information during network transit. In some implementations, the contact process implements retry mechanisms and fallback procedures that ensure reliable communication even during network congestion or temporary connectivity issues.

In step 506, the method includes receiving a list of available nodes capable of handling the requested AI processing task.

In some implementations, the global service registry responds with a curated list of candidate edge nodes that possess the necessary computational capabilities, available capacity, and appropriate AI models to execute the requested task efficiently. The node list may include detailed metadata for each candidate including current resource utilization levels, estimated processing times, reliability metrics, and specialized capabilities that could influence client selection decisions. In some implementations, the registry may implement intelligent filtering that prioritizes nodes based on factors such as geographic proximity within the home network, historical performance with similar tasks, or current load balancing requirements.

In some implementations, the received node list includes performance predictions and cost estimates that enable the client device to make informed decisions about resource selection. The list may be ordered according to various optimization criteria such as expected completion time, resource efficiency, or overall system load balancing considerations. In some implementations, the registry may provide alternative recommendations or suggest task decomposition strategies if no single node can handle the complete request within the specified constraints.

In step 508, the method includes selecting a target node from the available candidates for task execution.

In some implementations, the node selection process involves multi-criteria decision analysis that considers factors including expected performance, current availability, reliability history, and network connectivity quality. The selection mechanism may implement various decision algorithms ranging from simple preference-based selection to sophisticated optimization approaches that consider multiple objectives simultaneously. In some implementations, the client device may maintain historical performance data and user preferences that influence the selection process based on past experiences and application-specific requirements.

In some implementations, the selection process includes real-time validation that confirms the chosen node remains available and capable of handling the task since the initial registry query. The selection mechanism may implement backup planning that identifies alternative nodes in case the primary selection becomes unavailable during the connection establishment process. In some implementations, the selection includes negotiation capabilities that allow the client device to request specific service levels or performance guarantees from the target node.

In step 510, the method includes establishing a direct communication connection with the selected target node.

In some implementations, the connection establishment process bypasses the central coordination infrastructure to enable efficient peer-to-peer communication between the client device and the processing node. The direct connection mechanism may implement various networking protocols optimized for different types of data transmission, such as TCP for reliable data transfer or UDP for low-latency streaming applications. In some implementations, the connection establishment includes security handshake procedures that verify node authenticity, establish encrypted communication channels, and ensure data privacy throughout the processing session.

In some implementations, the connection process includes quality-of-service negotiation that establishes performance expectations, timeout parameters, and error handling procedures. The establishment mechanism may implement adaptive protocols that optimize connection parameters based on current network conditions and task requirements. In some implementations, the connection includes bandwidth reservation or traffic prioritization mechanisms that ensure reliable communication for time-sensitive AI processing tasks.

In step 512, the method includes transmitting task data to the selected processing node for execution.

In some implementations, the data transmission process involves efficient transfer of input data, task parameters, and execution instructions required for AI model processing. The transmission mechanism may implement various optimization techniques including data compression, streaming protocols, or progressive transfer methods that reduce latency and improve bandwidth utilization. In some implementations, the data transmission includes integrity verification mechanisms that ensure accurate delivery and detect any corruption during network transfer.

In step 514, the method includes waiting for processing results from the target node.

In some implementations, the waiting mechanism includes configurable timeout parameters that balance between allowing sufficient processing time and detecting potential execution failures or communication issues. The waiting process may implement status polling or notification mechanisms that provide periodic updates on processing progress for long-running tasks. In some implementations, the waiting includes interrupt capabilities that allow the client device to cancel requests or modify parameters during execution if requirements change.

If a timeout occurs, the method proceeds to step 516 to handle the timeout condition. In some implementations, timeout handling includes diagnostic procedures that attempt to determine whether the delay results from network issues, processing complexity, or node failures. The timeout handling mechanism may implement retry strategies with exponential backoff or alternative node selection to improve success probability.

If processing completes successfully, the method proceeds to step 518 to receive task results from the processing node. In some implementations, result reception includes validation of data integrity, format verification, and preliminary quality assessment to ensure successful task completion.

In step 520, the method includes validating the received results to ensure quality and completeness. In some implementations, validation includes comparison with expected output formats, confidence score verification for AI predictions, and consistency checks that detect potential processing errors.

In step 522, the method includes reporting task completion status to the global service registry for system coordination and performance tracking. In some implementations, the completion reporting includes performance metrics, quality assessments, and feedback that helps improve future resource allocation decisions.

Finally, in step 524, the method includes processing the results locally within the client device to complete the application workflow. In some implementations, local processing includes result integration with application logic, user interface updates, or triggering of subsequent automated actions based on the AI processing outcomes.

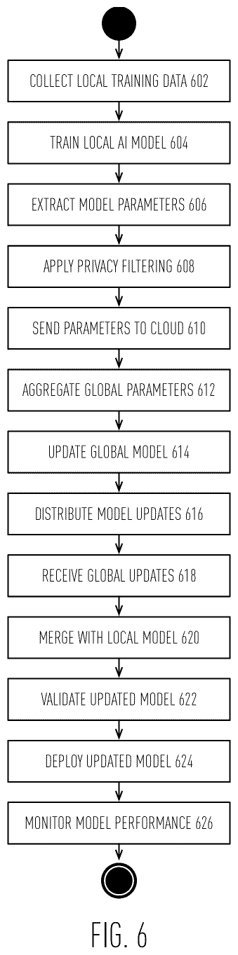

FIG. 6 is a flow diagram illustrating a method for federated learning implementation in a distributed artificial intelligence system according to some of the disclosed embodiments.

In step 602, the method includes collecting local training data from sources within the home network environment.

In some implementations, the local data collection process involves gathering training examples from various sensors, devices, and user interactions that occur naturally within the home environment while preserving user privacy and data sovereignty. The collected data may include image frames from security cameras, network traffic patterns from connected devices, audio samples from smart speakers, environmental sensor readings, or user behavior patterns from smart home interactions. In some implementations, the data collection mechanism implements intelligent sampling strategies that capture representative examples while minimizing storage requirements and computational overhead.

In some implementations, the local data collection includes automated labeling mechanisms that generate training labels based on context, user feedback, or cross-correlation with other data sources within the home environment. The collection process may implement data quality assessment algorithms that filter out corrupted samples, identify outliers, and ensure sufficient diversity in the training dataset. In some implementations, the collection mechanism includes temporal considerations that maintain balanced representation across different time periods, usage patterns, and environmental conditions to ensure robust model training.

In step 604, the method includes training a local AI model using the collected home-specific data.

In some implementations, the local training process utilizes machine learning algorithms optimized for edge computing environments with limited computational resources and memory constraints. The training mechanism may implement incremental learning techniques that continuously update model parameters as new data becomes available while avoiding catastrophic forgetting of previously learned patterns. In some implementations, the local training includes transfer learning approaches that leverage pre-trained foundation models and adapt them to specific home environment characteristics and user preferences.

In some implementations, the local training process implements adaptive algorithms that automatically adjust learning rates, batch sizes, and training duration based on available computational resources and data characteristics. The training mechanism may include regularization techniques that prevent overfitting to the limited local dataset while maintaining generalization capability. In some implementations, the training includes validation procedures that assess model performance using holdout data and implement early stopping mechanisms to prevent overtraining and optimize resource utilization.

In step 606, the method includes extracting model parameters from the locally trained AI model.

In some implementations, the parameter extraction process involves systematic identification and isolation of learned weights, biases, and other trainable components that capture the knowledge gained from local training data. The extraction mechanism may implement selective parameter identification that focuses on the most significant model components while filtering out parameters with minimal impact on model performance. In some implementations, the extraction includes parameter compression techniques that reduce data volume through quantization, pruning, or other optimization methods while preserving essential model characteristics.

In some implementations, the parameter extraction process includes metadata generation that provides context about the training process, data characteristics, and model performance metrics. The extraction mechanism may implement versioning systems that track parameter evolution over time and enable rollback capabilities if updated models perform poorly. In some implementations, the extraction includes statistical analysis that identifies parameter distributions, convergence characteristics, and stability metrics that inform the federated learning coordination process.

In step 608, the method includes applying privacy filtering to protect sensitive information before parameter sharing.

In some implementations, the privacy filtering process implements differential privacy techniques that add carefully calibrated noise to model parameters to prevent inference of individual training examples while preserving overall model utility. The filtering mechanism may include k-anonymity approaches that ensure parameter updates cannot be traced back to specific users or sensitive data sources within the home environment. In some implementations, the privacy filtering includes homomorphic encryption techniques that enable secure aggregation of encrypted parameters without exposing individual contributions.

In some implementations, the privacy filtering process includes sensitivity analysis that identifies parameters most likely to leak private information and applies enhanced protection mechanisms to these high-risk components. The filtering mechanism may implement adaptive privacy budgets that balance privacy protection with model utility based on data sensitivity classifications and user-specified privacy preferences. In some implementations, the filtering includes audit mechanisms that track privacy expenditure and ensure compliance with privacy policies and regulatory requirements.

In step 610, the method includes transmitting the privacy-filtered parameters to cloud-based federated learning infrastructure.

In some implementations, the transmission process implements secure communication protocols with end-to-end encryption, message authentication, and integrity verification to protect parameter data during network transit. The transmission mechanism may include adaptive compression and batching strategies that optimize bandwidth utilization while ensuring timely delivery of learning updates. In some implementations, the transmission includes quality-of-service mechanisms that prioritize federated learning traffic and implement retry strategies for reliable delivery under varying network conditions.

In step 612, the method includes aggregating parameters from multiple participating nodes in the cloud infrastructure.

In some implementations, the aggregation process implements sophisticated algorithms such as federated averaging, weighted aggregation based on data quality metrics, or robust aggregation techniques that filter out malicious or low-quality contributions. The aggregation mechanism may include convergence detection algorithms that determine when sufficient learning has occurred across the federated network. In some implementations, the aggregation includes fairness mechanisms that ensure balanced contribution from different participants and prevent domination by nodes with large datasets or high update frequencies.

In step 614, the method includes updating the global model based on aggregated parameters from distributed participants.

In some implementations, the global model update process implements sophisticated optimization algorithms that incorporate distributed learning insights while maintaining model stability and performance consistency. The update mechanism may include validation procedures that test global model performance across diverse evaluation datasets to ensure broad applicability and robustness. In some implementations, the update process includes version control systems that maintain historical model versions and enable rollback capabilities if performance degrades.

In step 616, the method includes distributing updated global model parameters back to participating nodes.

In some implementations, the distribution process implements efficient broadcast mechanisms that minimize bandwidth requirements while ensuring timely delivery of model updates to all participants. The distribution mechanism may include selective update strategies that send only changed parameters or incremental updates to reduce network overhead. In some implementations, the distribution includes quality verification mechanisms that ensure accurate delivery and provide feedback on successful model deployment across the federated network.

In step 618, the method includes receiving global model updates at the local edge node.

In some implementations, the reception process includes integrity verification, compatibility checking, and preliminary validation to ensure received updates are appropriate for the local deployment environment. The reception mechanism may implement buffering and scheduling capabilities that coordinate update deployment with ongoing local processing tasks.

In step 620, the method includes merging global updates with the local model to create an enhanced hybrid model.

In some implementations, the merging process implements intelligent combination strategies that preserve beneficial local adaptations while incorporating valuable global knowledge. The merging mechanism may include conflict resolution algorithms that handle situations where global and local parameters suggest different optimal values.

In step 622, the method includes validating the updated model to ensure performance improvements and stability.

In some implementations, the validation process includes comprehensive testing using local validation datasets, performance benchmarking, and comparison with previous model versions to confirm successful integration of global learning insights.

In step 624, the method includes deploying the validated updated model for production use within the home environment. In step 626, the method includes monitoring model performance to assess the effectiveness of federated learning integration and identify potential issues requiring attention.

In some implementations, the method can include checking whether to continue the federated learning cycle, enabling continuous improvement through ongoing collaboration with the distributed learning network or completing the learning process when sufficient performance has been achieved.

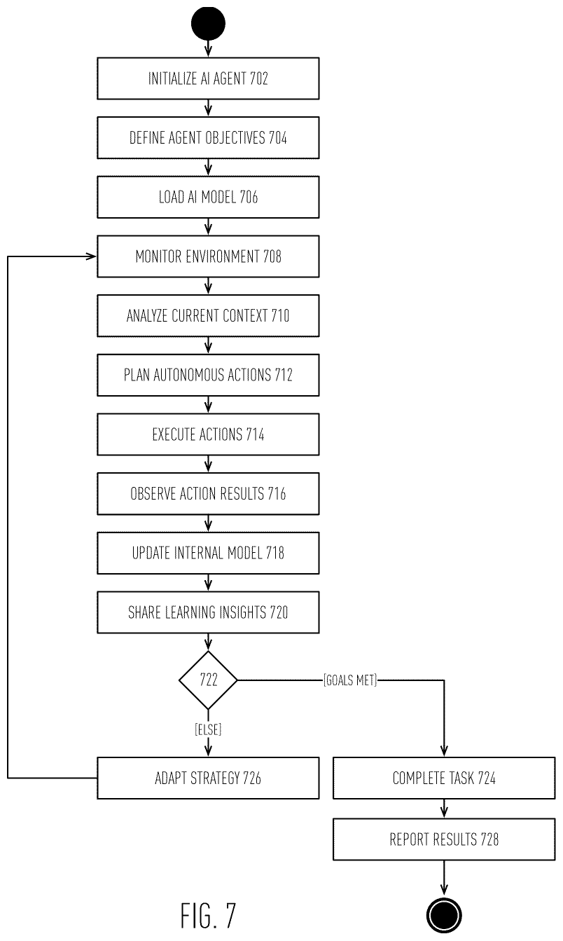

FIG. 7 is a flow diagram illustrating a method for agentic artificial intelligence implementation and autonomous operation in a distributed home network system according to some of the disclosed embodiments.

In step 702, the method includes initializing an AI agent within the distributed edge computing infrastructure.

In some implementations, the agent initialization process involves establishing the foundational software architecture, memory structures, and computational resources necessary for autonomous AI operation within the home network environment. The initialization may include loading core agent software components such as decision-making engines, learning algorithms, communication interfaces, and sensor integration modules that enable the agent to interact effectively with its environment. In some implementations, the initialization process includes establishing secure communication channels with other system components, registering agent capabilities with the distributed service registry, and configuring authentication credentials for secure operation within the home network infrastructure.

In some implementations, the agent initialization includes hardware resource allocation that assigns appropriate computational capacity, memory allocation, and storage resources based on the agent's intended role and complexity requirements. The initialization process may implement dynamic resource scaling capabilities that allow the agent to request additional resources as needed while maintaining efficient utilization of edge computing infrastructure. In some implementations, the initialization includes establishing monitoring and logging systems that track agent behavior, performance metrics, and learning progress throughout its operational lifecycle.

In step 704, the method includes defining specific objectives and goals for the autonomous AI agent.

In some implementations, the objective definition process involves translating high-level user requirements, system optimization goals, or application-specific targets into concrete, measurable objectives that guide agent decision-making and behavior. The objectives may include performance targets such as minimizing energy consumption, optimizing network utilization, improving user experience metrics, or maintaining security and privacy standards within the home environment. In some implementations, the objective definition includes hierarchical goal structures that enable the agent to pursue multiple objectives simultaneously while managing potential conflicts and trade-offs between competing priorities.

In some implementations, the objective definition process includes constraint specification that establishes operational boundaries, safety limits, and ethical guidelines that constrain agent behavior and ensure responsible autonomous operation. The objectives may be dynamic and adaptive, allowing for modification based on changing environmental conditions, user preferences, or system requirements. In some implementations, the definition includes success criteria and evaluation metrics that enable the agent to assess its own performance and adapt its strategies to achieve better outcomes over time.

In step 706, the method includes loading appropriate AI models that provide the cognitive capabilities necessary for autonomous operation.

In some implementations, the model loading process involves selecting and initializing machine learning models optimized for the agent's specific objectives and operational environment. The loaded models may include decision-making algorithms such as reinforcement learning models, planning algorithms, predictive models for environment simulation, and specialized domain-specific models for tasks like image recognition, natural language processing, or sensor data analysis. In some implementations, the model loading includes dynamic model selection capabilities that allow the agent to choose optimal models based on current task requirements and available computational resources.

In some implementations, the model loading process includes model optimization techniques such as quantization, pruning, or knowledge distillation that adapt models for efficient execution on edge computing hardware with limited resources. The loading mechanism may implement caching strategies that preload frequently used models while managing memory constraints effectively. In some implementations, the loading includes model versioning and update capabilities that enable the agent to incorporate improved models as they become available through federated learning or cloud-based model repositories.

In step 708, the method includes continuously monitoring the environment to maintain situational awareness.

In some implementations, the environmental monitoring process involves systematic collection and analysis of data from multiple sources including IoT sensors, network traffic analyzers, user behavior patterns, device status indicators, and external information sources. The monitoring mechanism may implement intelligent sampling strategies that balance comprehensive awareness with computational efficiency and privacy considerations. In some implementations, the monitoring includes anomaly detection algorithms that identify unusual patterns, potential security threats, or system malfunctions that require immediate attention or response.

In some implementations, the environmental monitoring process includes predictive capabilities that anticipate future conditions based on historical patterns, seasonal variations, and trend analysis. The monitoring mechanism may implement multi-modal sensor fusion that combines information from diverse sources to create comprehensive environmental understanding. In some implementations, the monitoring includes adaptive observation strategies that adjust monitoring frequency and focus based on current system state and anticipated changes.

In step 710, the method includes analyzing current context to understand the present situation and inform decision-making.

In some implementations, the context analysis process involves sophisticated interpretation of environmental data, system status, and user patterns to extract meaningful insights that guide autonomous decision-making. The analysis may include temporal reasoning that considers historical context, current conditions, and predicted future states when evaluating situations and potential responses. In some implementations, the context analysis includes uncertainty quantification that assesses confidence levels in different aspects of the current situation and incorporates uncertainty into decision-making processes.

In step 712, the method includes planning autonomous actions based on current context and defined objectives.

In some implementations, the action planning process employs advanced algorithms such as Monte Carlo tree search, deep reinforcement learning, or hierarchical planning that evaluate potential action sequences and select optimal strategies for achieving defined objectives. The planning mechanism may implement multi-objective optimization that balances competing goals while considering resource constraints and potential risks. In some implementations, the planning includes contingency preparation that develops alternative action plans for different possible future scenarios.

In step 714, the method includes executing the planned actions within the distributed system infrastructure.

In some implementations, the action execution process involves coordinating with other system components, issuing commands to controllable devices, adjusting system parameters, or triggering automated processes based on the planned strategy. The execution mechanism may implement safety checks and validation procedures that ensure actions are appropriate and will not cause harm to users or system infrastructure. In some implementations, the execution includes real-time adaptation capabilities that modify actions based on immediate feedback or unexpected environmental changes.

In step 716, the method includes observing the results and consequences of executed actions.

In some implementations, the result observation process involves systematic collection of outcome data, performance metrics, and environmental changes that result from the agent's actions. The observation mechanism may implement causal inference techniques that distinguish between changes caused by agent actions and those resulting from external factors. In some implementations, the observation includes user feedback integration that captures human responses and satisfaction levels related to agent behavior.

In step 718, the method includes updating the agent's internal model based on observed results and learning from experience.

In some implementations, the model update process employs machine learning algorithms that incorporate new experience data to improve future decision-making and action planning capabilities. The update mechanism may implement online learning techniques that continuously refine model parameters while maintaining stability and avoiding catastrophic forgetting. In some implementations, the updates include meta-learning capabilities that enable the agent to learn how to learn more effectively from new experiences.

In step 720, the method includes sharing learning insights with other agents or the federated learning system.

In some implementations, the knowledge sharing process involves extracting generalizable insights from local learning experiences and contributing them to the broader distributed intelligence network while preserving privacy and security. The sharing mechanism may implement selective knowledge transfer that identifies valuable insights while filtering out sensitive or agent-specific information.

In step 722, the method includes evaluating whether defined objectives have been achieved satisfactorily.

In some implementations, the goal evaluation process involves comparing current system state and performance metrics against defined success criteria to determine whether the agent has successfully completed its assigned tasks. If goals are met, the method proceeds to step 724 to complete the task and step 728 to report results. If objectives require continued effort, the method proceeds to step 726 to adapt strategy and continue the autonomous operation cycle, returning to environmental monitoring to begin the next iteration of intelligent autonomous behavior.

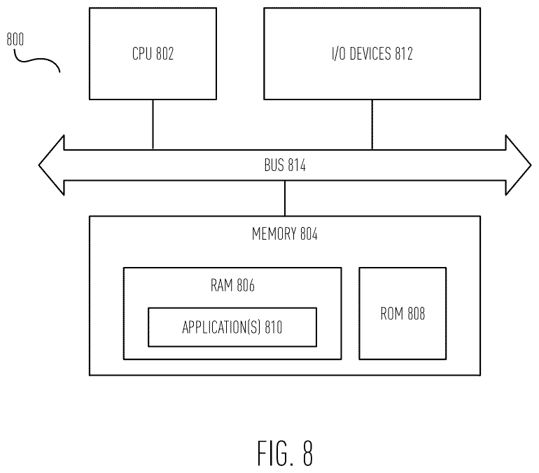

FIG. 8 is a block diagram of a computing device according to some embodiments of the disclosure.

As illustrated, the device 800 includes a processor or central processing unit (CPU) such as CPU 802 in communication with a memory 804 via a bus 814. The device also includes one or more input/output (I/O) or peripheral devices 812. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 802 may comprise a general-purpose processor. The CPU 802 may comprise a single-core or multiple-core processor. The CPU 802 may comprise a system-on-a-chip (SoC) processor or a similar embedded system or processor. In some embodiments, a graphics processing unit (GPU) may be used in place of, or in combination with, a CPU 802. Memory 804 may comprise a memory system including a dynamic random-access memory (DRAM), static random-access memory (SRAM), Flash (e.g., NAND Flash), or combinations thereof. In one embodiment, the bus 814 may comprise a Peripheral Component Interconnect Express (PCIe) bus. In some embodiments, the bus 814 may comprise multiple busses instead of a single bus.

Memory 804 illustrates an example of a non-transitory computer storage media for the storage of information such as computer-readable instructions, data structures, program modules, or other data. Memory 804 can store a basic input/output system (BIOS) in read-only memory (ROM), such as ROM 808 for controlling the low-level operation of the device. The memory can also store an operating system in random-access memory (RAM) for controlling the operation of the device.

Applications 810 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 806 by a processor, such as CPU 802. The CPU 802 may then read the software or data from RAM 806, process them, and store them in RAM 806 again.

The device may optionally communicate with a base station (not shown) or directly with another computing device. One or more network interfaces in peripheral devices 812 are sometimes referred to as a transceiver, transceiving device, or network interface card (NIC).

An audio interface in peripheral devices 812 produces and receives audio signals such as the sound of a human voice. For example, an audio interface may be coupled to a speaker and microphone (not shown) to enable telecommunication with others or generate an audio acknowledgment for some action. Displays in peripheral devices 812 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 812 may comprise any input device arranged to receive input from a user. An illuminator in peripheral devices 812 may provide a status indication or provide light. The device can also comprise an input/output interface in peripheral devices 812 for communication with external devices, using communication technologies, such as USB, infrared, Bluetooth®, or the like. A haptic interface in peripheral devices 812 provides tactile feedback to a user of the client device.

A GPS receiver in peripheral devices 812 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown in FIG. 8, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, AI accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
receiving, by a controller node, a task request from a client device within a home network environment;
querying, by the controller node, a global service registry to identify available edge nodes capable of executing artificial intelligence processing tasks;
scheduling, by the controller node, the task request at an optimal edge node from the available edge nodes based on current resource utilization and task requirements;
establishing, by the controller node, a direct communication connection between the client device and the selected edge node;
monitoring, by the controller node, execution of the artificial intelligence processing task on the selected edge node; and
coordinating, by the controller node, federated learning parameter synchronization between the selected edge node and a cloud-based learning server.

2. The method of claim 1, wherein querying the global service registry comprises receiving real-time resource metrics from a plurality of local service registries distributed across edge nodes in the home network environment.

3. The method of claim 1, wherein selecting the optimal edge node comprises evaluating candidate nodes based on one or more of processor utilization, memory availability, artificial intelligence model compatibility, or network connectivity quality.

4. The method of claim 1, wherein monitoring execution of the artificial intelligence processing task comprises tracking task progress, resource consumption, and performance metrics in real-time.

5. The method of claim 1, wherein coordinating federated learning parameter synchronization comprises applying privacy filtering to model parameters before transmission to the cloud-based learning server.

6. The method of claim 1, wherein the method further comprises distributing the artificial intelligence processing task across multiple edge nodes when the selected edge node has insufficient computational capacity.

7. The method of claim 1, wherein the client device comprises one of a smartphone, tablet, smart TV, IoT device, set-top box, camera, or access point.

8. A non-transitory computer-readable storage medium for tangibly storing computer program instructions capable of being executed by a computer processor, the computer program instructions defining steps of:
receiving, by a controller node, a task request from a client device within a home network environment;
querying, by the controller node, a global service registry to identify available edge nodes capable of executing artificial intelligence processing tasks;
scheduling, by the controller node, the task request at an optimal edge node from the available edge nodes based on current resource utilization and task requirements;
establishing, by the controller node, a direct communication connection between the client device and the selected edge node;
monitoring, by the controller node, execution of the artificial intelligence processing task on the selected edge node; and
coordinating, by the controller node, federated learning parameter synchronization between the selected edge node and a cloud-based learning server.

9. The non-transitory computer-readable storage medium of claim 8, wherein querying the global service registry comprises receiving real-time resource metrics from a plurality of local service registries distributed across edge nodes in the home network environment.

10. The non-transitory computer-readable storage medium of claim 8, wherein selecting the optimal edge node comprises evaluating candidate nodes based on one or more of processor utilization, memory availability, artificial intelligence model compatibility, or network connectivity quality.

11. The non-transitory computer-readable storage medium of claim 8, wherein monitoring execution of the artificial intelligence processing task comprises tracking task progress, resource consumption, and performance metrics in real-time.

12. The non-transitory computer-readable storage medium of claim 8, wherein coordinating federated learning parameter synchronization comprises applying privacy filtering to model parameters before transmission to the cloud-based learning server.

13. The non-transitory computer-readable storage medium of claim 8, wherein the steps further comprise distributing the artificial intelligence processing task across multiple edge nodes when the selected edge node has insufficient computational capacity.

14. The non-transitory computer-readable storage medium of claim 8, wherein the client device comprises one of a smartphone, tablet, smart TV, or IoT device.

15. A device comprising:
a processor;
a non-transitory computer-readable medium storing program instructions that, when executed by the processor, causes the processor to perform operations of:
receiving a task request from a client device within a home network environment;
querying a global service registry to identify available edge nodes capable of executing artificial intelligence processing tasks;
scheduling the task request at an optimal edge node from the available edge nodes based on current resource utilization and task requirements;
establishing a direct communication connection between the client device and the selected edge node;
monitoring execution of the artificial intelligence processing task on the selected edge node; and
coordinating federated learning parameter synchronization between the selected edge node and a cloud-based learning server.

16. The device of claim 15, wherein querying the global service registry comprises receiving real-time resource metrics from a plurality of local service registries distributed across edge nodes in the home network environment.

17. The device of claim 15, wherein selecting the optimal edge node comprises evaluating candidate nodes based on one or more of processor utilization, memory availability, artificial intelligence model compatibility, or network connectivity quality.

18. The device of claim 15, wherein monitoring execution of the artificial intelligence processing task comprises tracking task progress, resource consumption, and performance metrics in real-time.

19. The device of claim 15, wherein coordinating federated learning parameter synchronization comprises applying privacy filtering to model parameters before transmission to the cloud-based learning server.

20. The device of claim 15, wherein the operations further comprise distributing the artificial intelligence processing task across multiple edge nodes when the selected edge node has insufficient computational capacity.
